(19) United States
(12) Patent Application Publication
(10) Pub. No.: US 2015/0312744 A1
(43) Pub. Date: Oct. 29, 2015

(54) CONTROLLED DISCOVERY

(71) Applicants: Tapani LEPPÄNEN, Tampere (FI); Timo AALTONEN, Tampere (FI)

(72) Inventors: Tapani LEPPÄNEN, Tampere (FI); Timo AALTONEN, Tampere (FI)

(73) Assignee: Nokia Corporation, Espoo (FI)

(21) Appl. No.: 14/400,631

(22) PCT Filed: May 23, 2012
(86) PCT No.: PCT/FI2012/050493

§ 371 Date: Feb. 15, 2015

(51) Int. Cl. H04W 8/00; H04L 29/08; H04W 52/02; H04W 48/08; H04W 28/04; H04L 29/12; H04W 40/24

(52) U.S. Cl. CPC H04W 8/005; H04L 61/1541; H04L 67/16; H04W 40/246; H04W 48/08; H04W 28/044; H04W 52/02

(57) ABSTRACT

The invention relates to methods, apparatuses, systems and computer program products for discovery of nearby devices. To facilitate discovery of nearby, i.e. proximal, devices, a discovery control signal from a control device may be used to control the discovery, e.g. how or when the discovery is carried out. The devices may send proximity information based on the discovery they have carried out to be used by the control device or the control system. The control device, e.g. a server, may form the discovery control signal based on this proximity information. A proximity graph may be used in determining how the discovery is controlled. Controlling discovery by the devices may e.g. be done to avoid discovery collisions or to save energy.

### BACKGROUND

As the capabilities of portable computers and communication devices develop, new ways of collaboration have become possible. For example, in addition to sending information from one device to another via a mobile communication network, devices may be able to communicate directly from device to device, or use a local network such as WLAN to send information to each other. Users of these devices may thus be able to work together utilizing such device-to-device communication. To be able to do so, the devices need to be connected to each other over a communication channel.

There is, therefore, a need for solutions that provide for efficient ways to connect to devices that are in the vicinity of the user's device.

### SUMMARY

Now there has been invented an improved method and technical equipment implementing the method, by which the above challenge is alleviated. Various aspects of the invention include methods, apparatuses, systems and computer program products comprising computer programs, which are characterized by what is stated in the independent claims. Various embodiments of the invention are disclosed in the dependent claims.

To facilitate discovery of nearby, i.e. proximal, devices, a discovery control signal from a control device may be used to control the discovery, e.g. how or when the discovery is carried out. The devices may send proximity information based on the discovery they have carried out to be used by the control device or the control system. The control device, e.g. a server, may form the discovery control signal based on this proximity information. A proximity graph may be used in determining how the discovery is controlled. Controlling discovery by the devices may e.g. be done to avoid discovery collisions or to save energy.

According to a first aspect, there is provided a method comprising receiving a discovery control signal from a control device, and carrying out discovery of proximal devices based on said discovery control signal.

According to an embodiment, the method comprises sending proximity information of discovered proximal devices to said control device for creation of said discovery control signal based on said proximity information.

According to a second aspect, there is provided a method comprising forming a discovery control signal for controlling discovery of proximal devices, and sending said discovery control signal to a first device.

According to an embodiment of the first or second aspect, the method comprises receiving proximity information of discovered proximal devices, and forming said discovery control signal based on said proximity information. According to an embodiment, the method comprises forming a proximity graph using said proximity information, and forming said discovery control signal using said proximity graph. According to an embodiment, the method comprises receiving said proximity information from a plurality of devices, and sending discovery control signals to said plurality of devices in order to orchestrate discovery of proximal devices by said plurality of devices. According to an embodiment, the method comprises sending a second discovery control signal to a second device for controlling discovery by said first device and said second device for avoiding discovery collisions. According to an embodiment, said discovery control signal comprises timing information of said discovery of proximal devices, such as a time instance, series of time instances, or a frequency of discovery for example so that energy can be saved. According to an embodiment, said proximity information and/or said discovery control signal comprises an identification of a discovery channel. According to an embodiment, said proximity information comprises information indicative of distance.

According to a third aspect, there is provided an apparatus comprising at least one processor, memory including computer program code, the memory and the computer program code configured to, with the at least one processor, cause the apparatus to receive a discovery control signal from a control device, and carry out discovery of proximal devices based on said discovery control signal.

According to an embodiment, the apparatus comprises computer program code configured to, with the at least one processor, cause the apparatus to send proximity information of discovered proximal devices to said control device for creation of said discovery control signal based on said proximity information.

According to a fourth aspect, there is provided an apparatus comprising at least one processor, memory including computer program code, the memory and the computer program code configured to, with the at least one processor, cause the apparatus to form a discovery control signal for controlling discovery of proximal devices, and send said discovery control signal to a first device.

According to an embodiment of the third or fourth aspect, the apparatus comprises computer program code configured to, with the at least one processor, cause the apparatus to receive proximity information of discovered proximal devices, and form said discovery control signal based on said proximity information. According to an embodiment, the apparatus comprises computer program code configured to, with the at least one processor, cause the apparatus to form a proximity graph using said proximity information, and form said discovery control signal using said proximity graph. According to an embodiment, the apparatus comprises computer program code configured to, with the at least one processor, cause the apparatus to receive said proximity information from a plurality of devices, and send discovery control signals to said plurality of devices in order to orchestrate discovery of proximal devices by said plurality of devices. According to an embodiment, the apparatus comprises computer program code configured to, with the at least one processor, cause the apparatus to send a second discovery control signal to a second device for controlling discovery by said first device and said second device for avoiding discovery collisions. According to an embodiment, said discovery control signal comprises timing information of said discovery of proximal devices, such as a time instance, series of time instances, or a frequency of discovery for example so that energy can be saved. According to an embodiment, said proximity information and/or said discovery control signal comprises an identification of a discovery channel. According to an embodiment, said proximity information comprises information indicative of distance.

According to a fifth aspect there is provided a method, comprising carrying out a discovery of proximal devices, providing proximity information of discovered proximal devices to a control device for creation of a discovery control signal, forming a discovery control signal for controlling discovery of proximal devices based on said proximity information, providing said discovery control signal to a first device, and carrying out discovery of proximal devices based on said discovery control signal.

According to an embodiment, the method comprises forming a proximity graph using said proximity information, and forming said discovery control signal using said proximity graph. According to an embodiment, the method comprises forming said proximity information for a plurality of devices, and sending discovery control signals to said plurality of devices in order to orchestrate discovery of proximal devices by said plurality of devices. According to an embodiment, the method comprises sending discovery control signals to said plurality of devices for controlling discovery by said plurality of devices for avoiding discovery collisions. According to an embodiment, said discovery control signal comprises timing information of said discovery of proximal devices, such as a time instance, series of time instances, or a frequency of discovery, for example so that energy can be saved.

According to a sixth aspect there is provided a system comprising at least one processor, memory including computer program code, the memory and the computer program code configured to, with the at least one processor, cause the system to carry out a discovery of proximal devices, provide proximity information of discovered proximal devices to a control device for creation of a discovery control signal, form a discovery control signal for controlling discovery of proximal devices based on said proximity information, provide said discovery control signal to a first device, and carry out discovery of proximal devices based on said discovery control signal.

According to an embodiment, the system comprises computer program code configured to, with the at least one processor, cause the system to form a proximity graph using said proximity information, and form said discovery control signal using said proximity graph. According to an embodiment, the system comprises computer program code configured to, with the at least one processor, cause the system to form said proximity information for a plurality of devices, and provide discovery control signals to said plurality of devices in order to orchestrate discovery of proximal devices by said plurality of devices. According to an embodiment, the system comprises computer program code configured to, with the at least one processor, cause the system to provide discovery control signals to said plurality of devices for controlling discovery by said plurality of devices for avoiding discovery collisions. According to an embodiment, said discovery control signal comprises timing information of said discovery of proximal devices, such as a time instance, series of time instances, or a frequency of discovery, for example so that energy can be saved.

According to a seventh aspect there is provided an apparatus comprising means for receiving a discovery control signal from a control device, and means for carrying out discovery of proximal devices based on said discovery control signal.

According to an embodiment, the apparatus comprises means for sending proximity information of discovered proximal devices to said control device for creation of said discovery control signal based on said proximity information.

According to an eighth aspect there is provided an apparatus comprising means for forming a discovery control signal for controlling discovery of proximal devices, and means for sending said discovery control signal to a first device.

According to an embodiment of the seventh or eighth aspect, the apparatus comprises means for receiving proximity information of discovered proximal devices, means for forming said discovery control signal based on said proximity information. According to an embodiment, the apparatus comprises means for forming a proximity graph using said proximity information, means for forming said discovery control signal using said proximity graph. According to an embodiment, the apparatus comprises means for receiving said proximity information from a plurality of devices, and means for sending discovery control signals to said plurality of devices in order to orchestrate discovery of proximal devices by said plurality of devices. According to an embodiment, the apparatus comprises means for sending a second discovery control signal to a second device for controlling discovery by said first device and said second device for avoiding discovery collisions. According to an embodiment, said discovery control signal comprises timing information of said discovery of proximal devices, such as a time instance, series of time instances, or a frequency of discovery for example so that energy can be saved. According to an embodiment, said proximity information and/or said discovery control signal comprises an identification of a discovery channel. According to an embodiment, said proximity information comprises information indicative of distance.

According to a ninth aspect there is provided a system comprising means for carrying out a discovery of proximal devices, means for providing proximity information of discovered proximal devices to a control device for creation of a discovery control signal, means for forming a discovery control signal for controlling discovery of proximal devices based on said proximity information, means for providing said discovery control signal to a first device, and means for carrying out discovery of proximal devices based on said discovery control signal.

According to an embodiment, the system comprises means for forming a proximity graph using said proximity information, and means for forming said discovery control signal using said proximity graph. According to an embodiment, the system comprises means for forming said proximity information for a plurality of devices, and means for providing discovery control signals to said plurality of devices in order to orchestrate discovery of proximal devices by said plurality of devices. According to an embodiment, the system comprises means for providing discovery control signals to said plurality of devices for controlling discovery by said plurality of devices for avoiding discovery collisions. According to an embodiment, said discovery control signal comprises timing information of said discovery of proximal devices, such as a time instance, series of time instances, or a frequency of discovery, for example so that energy can be saved.

According to a tenth aspect there is provided a computer program product embodied on a non-transitory computer readable medium, comprising computer program code configured to, when executed on at least one processor, cause an apparatus or a system to receive a discovery control signal from a control device, and carry out discovery of proximal devices based on said discovery control signal.

According to an eleventh aspect there is provided a computer program product embodied on a non-transitory computer readable medium, comprising computer program code configured to, when executed on at least one processor, cause an apparatus or a system to form a discovery control signal for controlling discovery of proximal devices, and send said discovery control signal to a first device.

According to a twelfth aspect there is provided a computer program product embodied on a non-transitory computer readable medium, comprising computer program code configured to, when executed on at least one processor, cause an apparatus or a system to carry out a discovery of proximal devices, provide proximity information of discovered proximal devices to a control device for creation of a discovery control signal, form a discovery control signal for controlling discovery of proximal devices based on said proximity information, provide said discovery control signal to a first device, and carry out discovery of proximal devices based on said discovery control signal.

According to a thirteenth aspect there is provided a computer program product embodied on a non-transitory computer readable medium, comprising computer program code configured to, when executed on at least one processor, cause an apparatus or a system to carry out the method according to the first, second or fifth aspect.

According to a fourteenth aspect there is provided use of a control signal from a second device at a first device in controlling discovery of proximal third devices.

### DESCRIPTION OF THE DRAWINGS

In the following, various embodiments of the invention will be described in more detail with reference to the appended drawings, in which

FIGS. 1a, 1b and 1c show flow charts of methods according to example embodiments;

FIGS. 2a and 2b show a system and devices according to example embodiments;

FIGS. 3a and 3b show example systems for proximity-based services;

FIGS. 4a and 4b show proximity graphs according to example embodiments;

FIGS. 5a and 5b show flow charts for discovery of proximal devices according to example embodiments; and

FIG. 5c shows a flow chart for a system where discovery of proximal devices is facilitated according to an example.

### DESCRIPTION OF THE EXAMPLE EMBODIMENTS

In the following, several embodiments of the invention will be described in the context of discovery of proximal devices. It is to be noted, however, that the invention is not limited to discovery. In fact, the different embodiments have applications widely in any environment where optimization of forming communication connections between devices is required.

In the following, the various embodiments are explained with reference to systems that utilize proximity of other devices, e.g. sharing and multi-player game applications. Proximity of other devices may be detected e.g. when the application is started, that is, a discovery may be carried out. An application may try to e.g. create a Bluetooth connection to other devices for peer-to-peer communication.

In various embodiments, there may be a system of proximity-based services where the services are typically joint actions for several devices collaborating based on their proximity, that is, actions and services are available depending on other devices that are nearby.

For example, there may be envisioned smart space concepts in nomadic environments based on devices that are in the proximity of each other. There may not be many devices/services that are fixed in the space, and the proximity and connection configuration may be changing when devices are moving. For such envisioned concepts it may be useful to find out which devices are in the proximity of each other. It is not enough e.g. to perform service discovery to find all available services that can be connected to but to find services/devices that are e.g. in the same room or in the same space.

The various embodiments may be applied to group forming, as well. Many multi-user or collaborative applications and services require a notion of a group of users/devices. The embodiments may be used for a real-world based group forming technique, that is, to find devices/people that are nearby. Sharing and other collaborative applications may then utilize ad hoc groups formed in such manner.

Proximity information may be sensed by the devices using short range radios, light, sound etc., to find other devices that are in the proximity. Positioning techniques (GPS, indoor positioning) may be used, as well. In addition, some use cases may utilize additional information in addition to the proximity (distance)—it may be useful to know e.g. which devices are in the same room so that they can interact with each other. Proximity sensing based on radio signals may lack this information and other techniques may be used, e.g. audio beacon or light (e.g. infrared).

For some use cases it may be sufficient that one device is searching the nearby devices once an application or a task is launched. The proximity sensing may be quite slow, e.g. with Bluetooth it may take several tens of seconds, depending on the number of devices in the proximity. In a general case, for prolonged use and for faster response, the proximity information may be kept up-to-date all the time. The proximity information may be presented as a graph where a node denotes a device and an edge denotes the proximity.

In the present invention, it has been noticed that there may be problems in a traditional, straightforward proximity sensing/discovery approach. For example, several devices may use the same sensing technique at the same time, and this may disturb or completely block the sensing. For example, if several devices are performing Bluetooth discovery at the same time, the discovery may fail on all devices, i.e., no devices are found. As another example, it has been noticed that two-way sensing may be unnecessary: if A is in B's proximity, it is enough that only one of the devices is performing the sensing. In other words, it has been noticed that the overall functionality of discovery is not optimized.

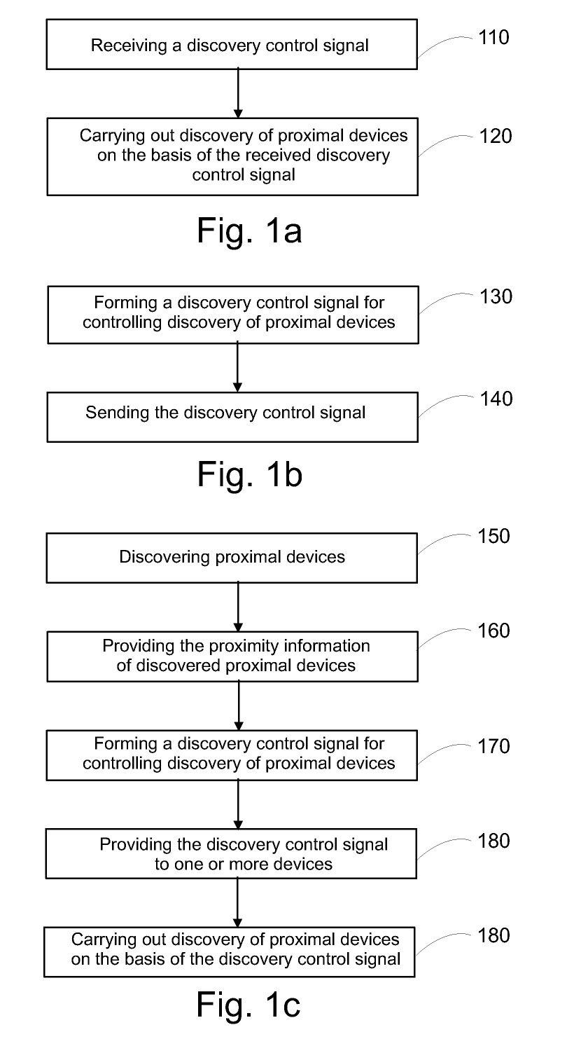

FIGS. 1a, 1b and 1c show flow charts of methods according to example embodiments.

In a device, a discovery control signal may be received from a control device such as a proximity server in phase 110. In phase 120, the device may carry out discovery of proximal devices based on the received discovery control signal. That is, the device may receive instructions or commands on when and how to perform discovery.

In a control apparatus, for example a proximity server or another device, a discovery control signal may be formed for controlling discovery of proximal devices in phase 130. In phase 140, the discovery control signal may be sent to a device. In other words, the proximity server or another device may control when and how a device that receives the discovery control signal is carrying out discovery of other devices.

In a system, discovery of proximal devices may be carried out in phase 150. In phase 160, the proximity information of discovered proximal devices may be provided to a control device for creation of a discovery control signal. In phase 170, a discovery control signal may be formed for controlling discovery of proximal devices based on the proximity information. In phase 180, the discovery control signal may be provided to one or more devices. In phase 190, the one or more devices may carry out discovery of proximal devices based on the discovery control signal. That is, the proximity information from various devices may be utilized by the proximity server to orchestrate how and/or when the various devices are carrying out discovery of other devices. The proximity information may comprise directly or indirectly distance information. For example, the received signal strength (e.g. in Bluetooth) may be such a measure in the proximity information, or the distance may be computed/determined by the device and given as such in the proximity information.

In a proximity service provided by the proximity server a device notices e.g. through discovery with a short-range radio that it is in another device's proximity and communicates this information to the proximity server that in turn provides this information for use in services based on proximity. The system may provide and use proximity information for e.g. proximity gaming, messaging, media streaming between devices etc. The proximity information may comprise information like discovered device identifications, WiFi access point information, cellular network cell id and such. The server may create a proximity graph.

Devices may discover other devices in the proximity using several heterogeneous techniques and provide this information to a proximity server. The proximity server may store and maintain the proximity information up-to-date, e.g. as a graph or more specifically, a data structure storing connection information (edges) between nodes and connection attributes. Radio-based environment fingerprinting (e.g. RSSI and device identification information) may be reported to the proximity server as well. This fingerprinting information may be collected during normal communication operation, and hence no position or local connection related measurements may be needed. The proximity server may combine this fingerprinting information reported by different devices and orchestrate local measurements based on this information.

The proximity server may orchestrate the devices' discovery based on the current and past proximity information, e.g. the proximity graph. This may allow global optimization for the proximity discovery (sensing) to reduce power consumption, discovery collisions, and to get more accurate proximity information by controlling the use of heterogeneous sensing technologies available on the devices. For example, the server may instruct or control the devices to use a certain discovery technique (WLAN, Bluetooth, sound beacon, infrared beacon) and/or a certain power (e.g. radio transmission power, sound volume), and also regulate which devices and when will perform the discovery. This controlling or instructing may happen by using a discovery control signal, e.g. sending parameters to the devices on how they perform discovery, and the devices may then use these parameters. The devices may also modify the received parameters or discovery control information.

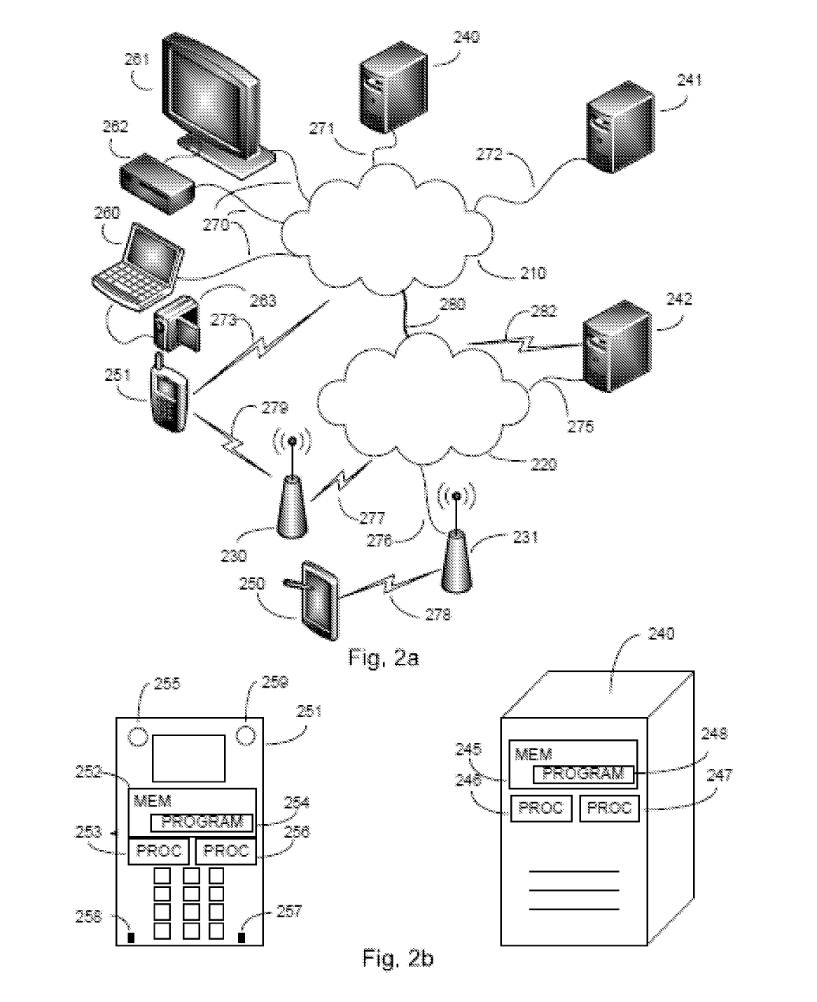

FIGS. 2a and 2b shows a system and devices for controlling discovery according to an embodiment. In FIG. 2a, the different devices may be connected via a fixed network 210 such as the Internet or a local area network; or a mobile communication network 220 such as the Global System for Mobile communications (GSM) network, 3rd Generation (3G) network, 3.5th Generation (3.5G) network, 4th Generation (4G) network, Wireless Local Area Network (WLAN), Bluetooth®, or other contemporary and future networks. Different networks are connected to each other by means of a communication interface 280. The networks comprise network elements such as routers and switches to handle data (not shown), and communication interfaces such as the base stations 230 and 231 in order for providing access for the different devices to the network, and the base stations 230, 231 are themselves connected to the mobile network 220 via a fixed connection 276 or a wireless connection 277.

There may be a number of servers connected to the network, and in the example of FIG. 2a are shown a server 240 for offering a network service for proximity service and controlling proximal discovery and connected to the fixed network 210, a server 241 for processing (e.g. filtering) proximity data and connected to the fixed network 210, and a server 242 for offering a network service e.g. a social networking service and connected to the mobile network 220. Some of the above devices, for example the computers 240, 241, 242 may be such that they make up the Internet with the communication elements residing in the fixed network 210.

There are also a number of end-user devices such as mobile phones and smart phones 251, Internet access devices (Internet tablets) 250, personal computers 260 of various sizes and formats, televisions and other viewing devices 261, video decoders and players 262, as well as video cameras 263 and other encoders. These devices 250, 251, 260, 261, 262 and 263 can also be made of multiple parts. The various devices may be connected to the networks 210 and 220 via communication connections such as a fixed connection 270, 271, 272 and 280 to the internet, a wireless connection 273 to the internet 210, a fixed connection 275 to the mobile network 220, and a wireless connection 278, 279 and 282 to the mobile network 220. The connections 271-282 are implemented by means of communication interfaces at the respective ends of the communication connection.

FIG. 2b shows devices for controlling proximal device discovery according to an embodiment. As shown in FIG. 2b, the server 240 contains memory 245, one or more processors 246, 247, and computer program code 248 residing in the memory 245 for implementing, for example, proximity service functionality. The different servers 241, 242 may contain at least these same elements for employing functionality relevant to each server. Similarly, the end-user device 251 contains memory 252, at least one processor 253 and 256, and computer program code 254 residing in the memory 252 for implementing, for example, controlled discovery of proximal devices. The end-user device may also have one or more cameras 255 and 259 for capturing image data, for example video. The end-user device may also contain one, two or more microphones 257 and 258 for capturing sound. The different end-user devices 250, 260 may contain at least these same elements for employing functionality relevant to each device. The end user devices may also comprise a screen for viewing a graphical user interface. The end-user devices and servers may also comprise various communication modules or communication functionalities implemented in one module for communicating with other devices and for carrying out discovery of nearby devices.

The various end-user devices and servers may take the form of communication devices, or other devices having communication capability. For example, the devices may be toys, home appliances like kitchen machines, entertainment devices (TV, music/media devices), or even parts of the building, clothes, vehicles, or any other devices that may communicate with each other and whose discovery may thus be controlled.

It needs to be understood that different embodiments allow different parts to be carried out in different elements. For example, determining proximity information or handling a discovery control signal may be carried out entirely in one user device like 250, 251 or 260, or in one server device 240, 241, or 242, or across multiple user devices 250, 251, 260 or across multiple network devices 240, 241, 242, or across both user devices 250, 251, 260 and network devices 240, 241, 242. For example, the proximity information may be formed and stored in one device, the discovery of proximal devices may happen in another device and the control of the proximity discovery may be carried out in a third device (e.g. a server). The relevant software for carrying out the functionality may reside on one device or distributed across several devices, as mentioned above, for example so that the devices form a so-called cloud.

The different embodiments may be implemented as software running on mobile devices and optionally on services. The mobile phones may be equipped at least with a memory, processor, display, keypad, motion detector hardware, and communication means such as 2G, 3G, WLAN, or other. The different devices may have hardware like a touch screen (single-touch or multi-touch) and means for positioning like network positioning or a global positioning system (GPS) module. There may be various applications on the devices such as a calendar application, a contacts application, a map application, a messaging application, a browser application, a gallery application, a video player application and various other applications for office and/or private use. The devices may have various communication modules for communicating with other devices and discovering proximal devices.

The proximity server may maintain a proximity graph for use in various services. The proximity information may be filtered for various services, e.g. a dating service, and this filtering may happen at the proximity server or at another unit. A service server (e.g. for the dating service) may receive notifications of changes in devices' proximity groups from the filtering unit and produce the actual service which is visible to the end user. In the various embodiments, the proximal discovery of other devices may be controlled and orchestrated e.g. by the proximity server or another server.

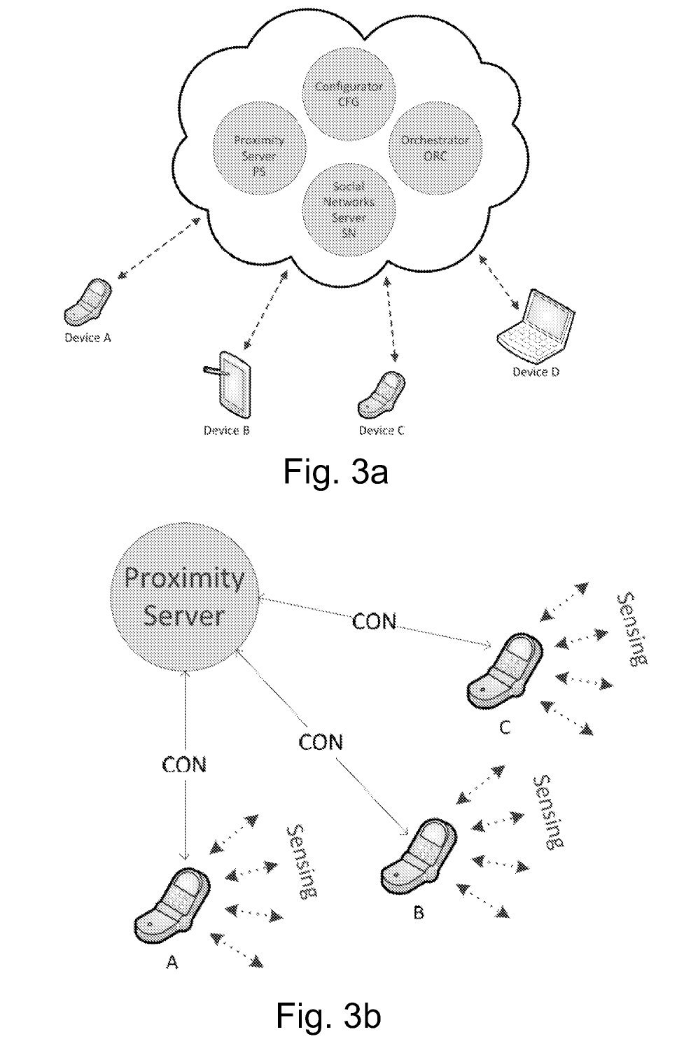

FIGS. 3a and 3b show example systems for proximity-based services. One system for proximity-based services is presented in FIG. 3a. Proximity Server PS may orchestrate proximity sensing and maintain a proximity graph of devices as explained later in this description. The joint actions/collaborative applications, in which the devices participate, may have a precondition requiring that devices are, e.g. 1) in the proximity of each other (PS), 2) “friends”, or more accurately they belong to the same social group or their social distance is smaller than a given threshold, e.g. the human owners are friends/in the same group, they are friends of a friend etc., and/or 3) capable to perform their part or role in the joint action/collaborative application, e.g. in an interaction dialog devices need to be able to communicate with each other.

A social network server SN may provide social network information. A configurator CFR may take the information from SN and PS, and the configurator CFG itself may have information about each device's capabilities. Combining this information with the precondition of each action, the configurator CFG may produce a list of possible actions fulfilling the preconditions. An action is picked from the list of possible actions based on e.g. some ranking algorithm. The orchestrator ORC may be responsible for executing the action by sending a control signal to participating devices to execute a role as specified in the action description, e.g. Device A has a storage containing a JPEG image (a photo source), Device B is a public display (sink for JPEG images).

FIG. 3b presents one system configuration. A proximity Server PS may store the discovery data sensed by the Device A, B and C. There may be a two-way connection “CON” between each device and the Proximity Server, or transport of information may be arranged in another manner, e.g. using a packet network. Devices may be using various, heterogeneous techniques to discover the proximity of other devices, e.g. Bluetooth discovery, WLAN access point information, cellular base station information, GPS and other satellite-based location information, various indoor positioning techniques (based on e.g. WLAN, BT) and/or light or sound beacons (beacons fixed in the space or one mobile device acting as a beacon). The proximity server PS may post-process the discovery data.

When a device joins the system, the proximity server may create a representation of the device—e.g. a node in a graph. In the simplest form, the server may control each device by sending a discovery control signal to the device instructing when (or how often) the device should sense its surroundings to perform a discovery, and which technology to use, e.g. with an instruction containing the information “Perform a Bluetooth scan periodically every 120 seconds with power level 3”.

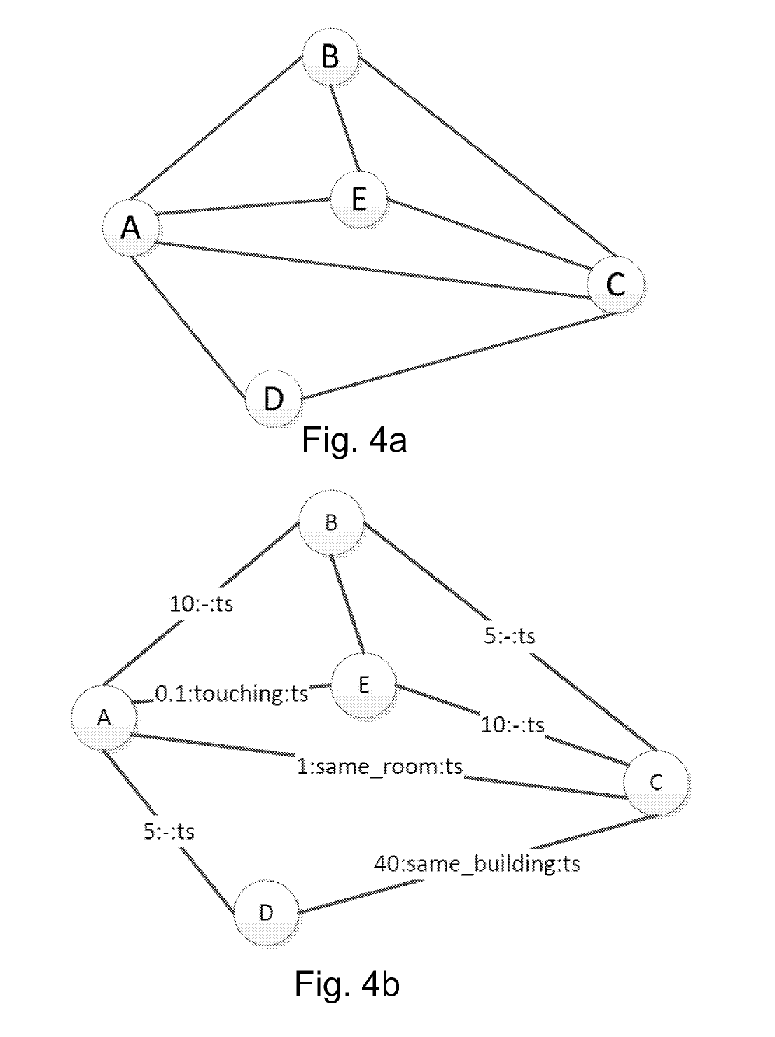

FIGS. 4a and 4b show proximity graphs according to example embodiments.

In FIG. 4a, the various devices are represented by nodes A, B, C, D and E. Device A is in the proximity of all other devices B, C, D and E. Device B is in the proximity of device A (reciprocally) and with devices C and E. Device C is proximal to all other devices, and device D is proximal to devices A and C. Device E is proximal to devices A, B and C. It needs to be noted that the proximity of two devices with each other may be discovered by one device, e.g. device A may discover device D, and it may be deduced that device A is also proximal to device D without device D doing any discovery. That is, proximity may be interpreted to be reciprocal.

In an embodiment, the proximity server PS may orchestrate the devices based on the current and past proximity graph information. The proximity information may thus be stored as a graph as depicted in FIG. 4a. The graph edges may have e.g. the following information: 1) a distance between devices, estimated from the discovery and expressed e.g. in meters, 2) time stamp indicating the time when the discovery of the proximity data corresponding to the edge was carried out and 3) additional proximity data, e.g. indicating whether the devices are touching (detected e.g. with NFC), in the same_room, or in the same_building.

In FIG. 4b, the same proximity graph as in FIG. 4a shows properties of the proximity connections (the edges of the graph). For example, the proximity between devices A and E has the properties of a distance of 0.1 meters, the information that the devices are touching (through NFC), and a time stamp when the proximity was discovered.

The proximity server PS may also keep track of what capabilities each device has for proximity discovery and the status of each technique. This is illustrated in the below table.

Device: Device A

| Sensing technique | Status | Data |
|---|---|---|
| Bluetooth | Active | Device B, Device C |
| GPS | Inactive | — |
| Cell ID | Connected | LAC: 18994 |
| | | Cell ID: 40992 |
| | | MCC: 310 |
| | | MNC: 1040 |
| . . . | . . . | . . . |

In the table, each device (shown here for device A only) may have a list of sensing (discovery) techniques for discovering proximal devices. Such techniques, or discovery channels, may be, as shown, e.g. Bluetooth, GPS, cellular network Cell ID and others. Each discovery channel may have an associated status information such as active, inactive and connected. For each discovery channel, there may be additional proximity information such as discovered proximal device identifiers (shown for Bluetooth), or cell identification information. It needs to be noted that it may be relevant information for the system that no proximal devices have been discovered (found), that is, it can be expected that there are no devices to communicate with. This information can also be stored in the system.

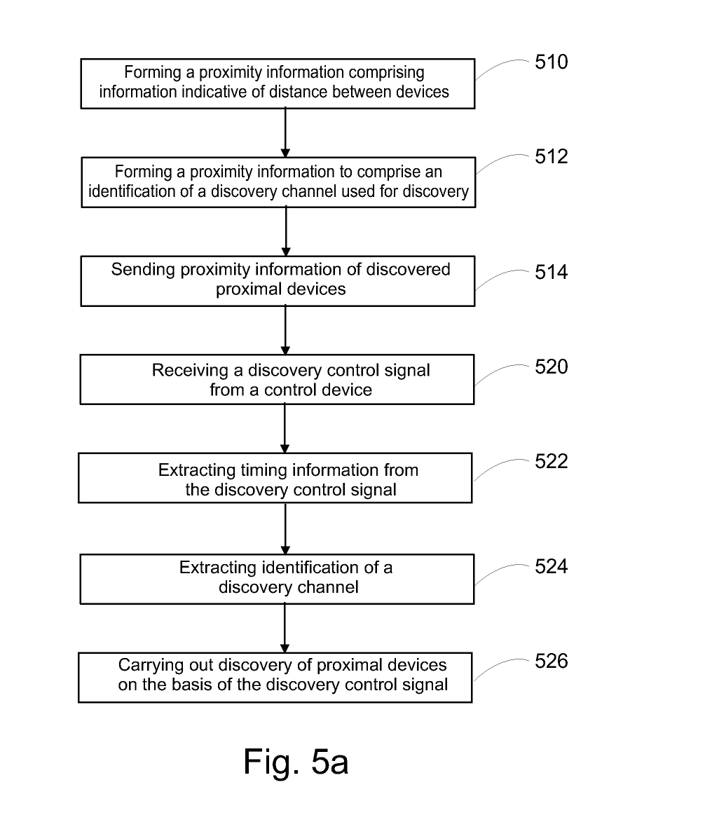

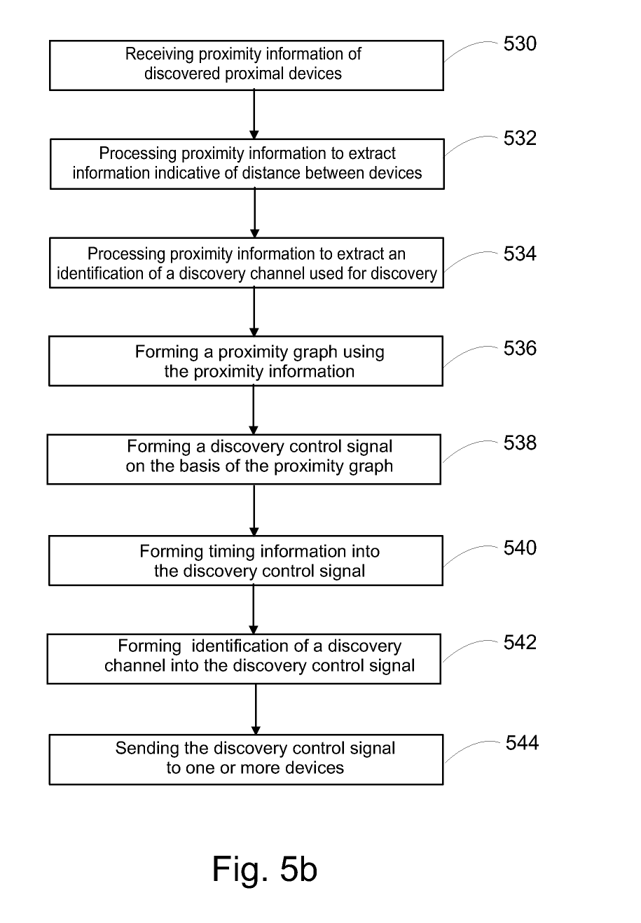

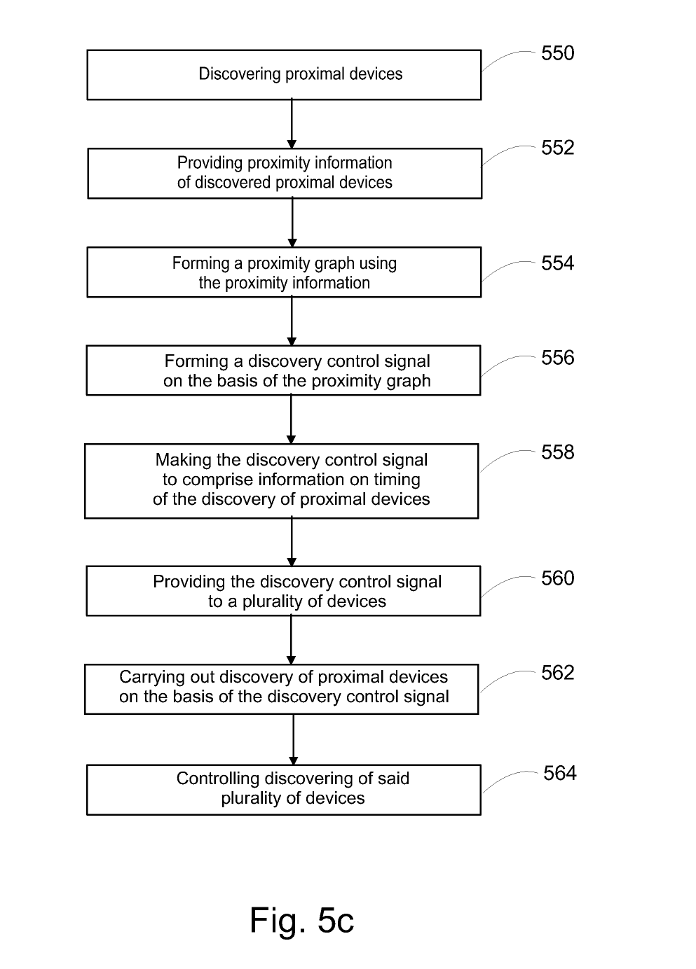

FIGS. 5a and 5b show flow charts for discovery of proximal devices according to example embodiments.

In a device, in phase 510, proximity information comprising information indicative of distance between devices may be formed. In phase 512, the proximity information may be formed to comprise an identification of a discovery channel used for discovery. In phase 514, proximity information of discovered proximal devices may be sent to a control device for creation of a discovery control signal based on the proximity information. In phase 520, a discovery control signal may be received from a control device. In phase 522, timing information may be extracted from the discovery control signal e.g. on timing of the discovery of proximal devices to be done, such as a time instance or a frequency of discovery for example so that energy can be saved or discovery collisions can be avoided. That is, timing information may comprise e.g. the next time instance for performing discovery, a series of time instances for performing discovery, a frequency of discovery attempts to be performed, or other time-related information e.g. for delaying discovery by a certain time if another device is detected to be performing discovery or communication at the same time (for collision avoidance). The device may also e.g. randomly modify the received timing. In phase 524, identification of a discovery channel may be extracted from the discovery control signal to determine how the discovery is to be carried out (which channel to use, e.g. Bluetooth or WLAN). In phase 526, discovery of proximal devices based on the discovery control signal may be carried out.

In a control device such as a proximity server, in phase 530, proximity information of discovered proximal devices may be received from a plurality of devices (one or more devices). In phase 532, proximity information may be processed to extract information indicative of distance between devices. In phase 534, proximity information may be processed to extract an identification of a discovery channel used in the discovery. In phase 536, a proximity graph may be formed using the proximity information. For example, the proximity graph may be updated with new information and previous proximity graph information may be stored as history data. A new proximity graph may be formed if a previous proximity graph does not exist. The forming and updating of the proximity graph may employ techniques for spanning a network, e.g. so that the graph is traversed starting from one node using e.g. depth-first or breadth-first traversing. In phase 538, a discovery control signal for controlling discovery of proximal devices based on the proximity graph may be formed. In phase 540, timing information may be formed into the discovery control signal on timing of the discovery of proximal devices, such as a time instance or a frequency of discovery for example so that energy can be saved. In phase 542, identification of a discovery channel to be used may be formed into the discovery control signal. In phase 544, the discovery control signal may be sent to one or more devices for controlling discovery by the devices for avoiding discovery collisions, in an orchestrated manner.

FIG. 5c shows a flow chart for a system where discovery of proximal devices is facilitated according to an example.

In phase 550, discovery of proximal devices may be carried out. In phase 552, proximity information of discovered proximal devices may be provided to a control device for creation of a discovery control signal. In phase 554, a proximity graph may be formed using the proximity information. In phase 556, a discovery control signal may be formed for controlling discovery of proximal devices based on the proximity graph. In phase 558, the discovery control signal may be made to comprise information on timing of the discovery of proximal devices, such as a time instance or a frequency of discovery, for example so that energy can be saved. In phase 560, a discovery control signal may be provided to a plurality of devices in order to orchestrate discovery of proximal devices. In phase 562, discovery of proximal devices may be carried out based on the discovery control signal in an orchestrated manner. In phase 564, discovery by said plurality of devices may be controlled for avoiding discovery collisions.

In one example, the server may obtain proximity information from a first device, e.g. comprising information that a second device is nearby and has been discovered at a certain time. The server may then control the future discovery actions of the first device, and the server may also control the discovery actions of the second device even though the second device has not sent proximity information to the server. In other words, the proximity information, wherever it has been obtained from, may be used to control the discovery of nearby devices by any device regardless of whether or not that device has sent proximity information to the server.

A proximity server PS may carry out and/or provide the following functionalities: orchestration of proximal discovery/sensing, maintaining edge time-to-live information, construction and maintaining a proximity graph, avoiding concurrent discovery and orchestrating beacon/observer functionality. These will be described in the following.

The proximity server PS may control which devices perform the discovery and by which technique, and at which time. The proximity server PS may control each discovery action separately or command a periodic discovery. The device may report the status of its sensing techniques to the server. For example, if GPS positioning is used for some other application and therefore its status is “active” even if the proximity server PS has not instructed to activate the GPS, the proximity server PS can then instruct the device to send GPS location periodically because the GPS is already on.

Each edge in the proximity graph representing proximity between two devices may have a time stamp value indicating when the proximity sensing was carried out. When new sensing information becomes available, the time stamp may be updated. The proximity may be sensed with various techniques, e.g. initial edge in the graph may be created based on NFC (near-field communication) touch gesture and the edge time stamp may be updated based on Bluetooth discovery. In this case also the proximity Distance and Additional proximity data may be updated. Alternatively or in addition, the time stamp may be specific to a discovery channel, i.e. not just to the edge.

In traditional solutions, constructing and updating a proximity graph would be expensive: For example, to get to a complete proximity graph, all the devices need to be discovering their environment periodically.

The various embodiments may alleviate this problem through the use of proximity information to control the proximal discovery, e.g. by exploiting the characteristics of different radio technologies. For example, it is relatively safe to let two devices that hear different cellular base stations to discover their environment with Bluetooth simultaneously—due to the shorter range of Bluetooth, the discovery signals would not disturb each other (no collision would be caused). Correspondingly, devices hearing the same Wi-Fi (WLAN) access point are likely to be relatively near to each other. If a sufficient number of edges have been found in a local area according to one discovery channel (e.g. the same Wi-Fi access point area), the sensing interval can be lengthened or suspended altogether for some devices. That is, if it can be deduced from one discovery channel information that devices may be near each other, a discovery control signal may be provided to the devices in order to limit their discovery and thus avoid discovery collisions.

If devices A, B and C are in the proximity of each other, the proximity server PS may instruct the devices to perform the discovery so that their individual sensing periods do not overlap and hence block/disturb the sensing. This may provide the advantage that discovery is more successful than without this orchestrating.

The proximity server PS may command device A to function as a beacon (e.g. by transmitting audio or infrared light) and command devices B and C to listen to that beacon. The proximity server PS may choose any devices that should participate to this, especially to test if devices that are known to be in the proximity (based on some other sensing technique, e.g. Bluetooth) are actually e.g. in the same room. Bluetooth may indicate that the devices are near each other, but if they are not able to observe the beacon, it may be determined that they are not in the same room.

The various embodiments may provide advantages. Orchestrating the discovery may reduce failed proximity sensing caused by unwanted concurrent sensing. The discovery control may also make it possible to utilize device resources effectively, for example to save battery. Controlling the use of various discovery techniques (for example, the use of several different techniques for discovery), the embodiments may provide additional information (e.g. which devices are in the same room) This may happen by controlling the used sensing techniques, e.g. by orchestrating an audio beacon and observer behavior alongside a discovery using a radio channel.

The various embodiments of the invention can be implemented with the help of computer program code that resides in a memory and causes the relevant apparatuses to carry out the invention. For example, a device may comprise circuitry and electronics for handling, receiving and transmitting data, computer program code in a memory, and a processor that, when running the computer program code, causes the terminal device to carry out the features of an embodiment. Yet further, a network device may comprise circuitry and electronics for handling, receiving and transmitting data, computer program code in a memory, and a processor that, when running the computer program code, causes the network device to carry out the features of an embodiment.

It is obvious that the present invention is not limited solely to the above-presented embodiments, but it can be modified within the scope of the appended claims.

1-50. (canceled)

51. A method, comprising:
forming a discovery control signal for controlling discovery of proximal devices, and
sending said discovery control signal to a first device.

52. A method according to claim 51, comprising:
receiving proximity information of discovered proximal devices, and
forming said discovery control signal based on said proximity information.

53. A method according to claim 52, comprising:
forming a proximity graph using said proximity information, and
forming said discovery control signal using said proximity graph.

54. A method according to claim 51, comprising:
receiving said proximity information from a plurality of devices, and
sending discovery control signals to said plurality of devices in order to orchestrate discovery of proximal devices by said plurality of devices.

55. A method according to claim 51, comprising:
sending a second discovery control signal to a second device for controlling discovery by said first device and said second device for avoiding discovery collisions.

56. A method according to claim 51, wherein said discovery control signal comprises timing information of said discovery of proximal devices, such as a time instance, series of time instances, or a frequency of discovery for example so that energy can be saved.

57. A method according to claim 51, wherein at least one of said proximity information and said discovery control signal comprises an identification of a discovery channel.

58. An apparatus comprising at least one processor, at least one memory including computer program code for one or more program units, the at least one memory and the computer program code configured to, with the processor, cause the apparatus to perform at least the following:
form a discovery control signal for controlling discovery of proximal devices, and
send said discovery control signal to a first device.

59. An apparatus according to claim 58, further comprising computer program code configured to, with the at least one processor, cause the apparatus to perform at least the following:
receive proximity information of discovered proximal devices, and
form said discovery control signal based on said proximity information.

60. An apparatus according to claim 59, further comprising computer program code configured to, with the at least one processor, cause the apparatus to perform at least the following:
form a proximity graph using said proximity information, and
form said discovery control signal using said proximity graph.

61. An apparatus according to claim 58, further comprising computer program code configured to, with the at least one processor, cause the apparatus to perform at least the following:
receive said proximity information from a plurality of devices, and
send discovery control signals to said plurality of devices in order to orchestrate discovery of proximal devices by said plurality of devices.

62. An apparatus according to claim 58, further comprising computer program code configured to, with the at least one processor, cause the apparatus to perform at least the following:
send a second discovery control signal to a second device for controlling discovery by said first device and said second device for avoiding discovery collisions.

63. An apparatus according to claim 58, wherein said discovery control signal comprises timing information of said discovery of proximal devices, such as a time instance, series of time instances, or a frequency of discovery for example so that energy can be saved.

64. An apparatus according to claim 58, wherein at least one of said proximity information and said discovery control signal comprises an identification of a discovery channel.

65. A computer program product including one or more sequences of one or more instructions which, when executed by one or more processors, cause a system to perform at least the following:
form a discovery control signal for controlling discovery of proximal devices, and
send said discovery control signal to a first device.

66. A computer program product according to claim 65, wherein the computer-executable program code portion further comprise program code instructions configured to:
receive proximity information of discovered proximal devices, and
form said discovery control signal based on said proximity information.

67. A computer program product according to claim 66, wherein the computer-executable program code portion further comprise program code instructions configured to:
form a proximity graph using said proximity information, and
form said discovery control signal using said proximity graph.

68. A computer program product according to claim 65, wherein the computer-executable program code portion further comprise program code instructions configured to:
receive said proximity information from a plurality of devices, and
send discovery control signals to said plurality of devices in order to orchestrate discovery of proximal devices by said plurality of devices.

69. A computer program product according to claim 65, wherein the computer-executable program code portion further comprise program code instructions configured to:
send a second discovery control signal to a second device for controlling discovery by said first device and said second device for avoiding discovery collisions.

70. A computer program product according to claim 65, wherein said discovery control signal comprises timing information of said discovery of proximal devices, such as a time instance, series of time instances, or a frequency of discovery for example so that energy can be saved.
